(19) United States
(12) Patent Application Publication
(10) Pub. No.: US 2026/0008187 A1
(43) Pub. Date: Jan. 8, 2026

(54) UNIVERSAL HUB FOR ROBOTIC END EFFECTORS

(71) Applicant: Dexterity, Inc., Redwood City, CA (US)

(72) Inventors: Samir Menon, Atherton, CA (US); Andrew Lovett, San Mateo, CA (US); Julia Wettersten, Redwood City, CA (US); Adam Curtis, Redwood City, CA (US); Jason Kmec, Redwood City, CA (US); Robert Holmberg, Mountain View, CA (US)

(21) Appl. No.: 19/181,217

(22) Filed: Apr. 16, 2025

Related U.S. Application Data
(60) Provisional application No. 63/636,036, filed on Apr. 18, 2024.

(51) Int. Cl. B25J 15/04; B25J 15/06; B25J 19/00

(52) U.S. Cl. CPC B25J 15/045; B25J 15/0616; B25J 19/0033

(57) ABSTRACT

A universal gripper system is disclosed. In various embodiments, the gripper system includes a hub body; a mounting structure configured to enable the hub body to be connected to the distal end of a robotic arm; a palm interface configured to removably mechanically couple to the hub body an interchangeable palm or tool; and a resource supply structure configured to supply a resource to the interchangeable palm or tool.

### CROSS REFERENCE TO OTHER APPLICATIONS

This application claims priority to U.S. Provisional Patent Application No. 63/636,036 entitled UNIVERSAL HUB FOR ROBOTIC END EFFECTORS filed Apr. 18, 2024, which is incorporated herein by reference for all purposes.

### BACKGROUND OF THE INVENTION

Certain robots can use multiple different grippers, each of which is tuned to specific tasks/applications. Some robots are configured to choose between different tools to enable more optimal performance of variable tasks by the same robot. Even in multi-tool robot applications, variable robot sizes or types across broad applications require different gripper “hubs” to mate with variable mounting patterns, accept variable sensors or actuators, differing load capacities, handle widely variable toolsets, etc.

Typically, grippers must be changed manually, requiring a skilled workforce, precision tools, and time.

Certain grippers require resources (power, vacuum, compressed air, etc.) to operate and may rely on sensors connected via the robotic arm. In robots with vacuum gripping and a force/torque sensor, for example, typically vacuum lines must be routed from above to below the force/torque sensor. Vacuum lines must not be rigid so that they don't dilute the force/torque readings at the force sensor. Typically, vacuum lines are soft tube/hose which is routed in a loop around the force/torque sensor to minimize force transmission—this can be large, heavy, lots of parts, challenging maintenance and supply chain.

### BRIEF DESCRIPTION OF THE DRA WINGS

Various embodiments of the invention are disclosed in the following detailed description and the accompanying drawings.

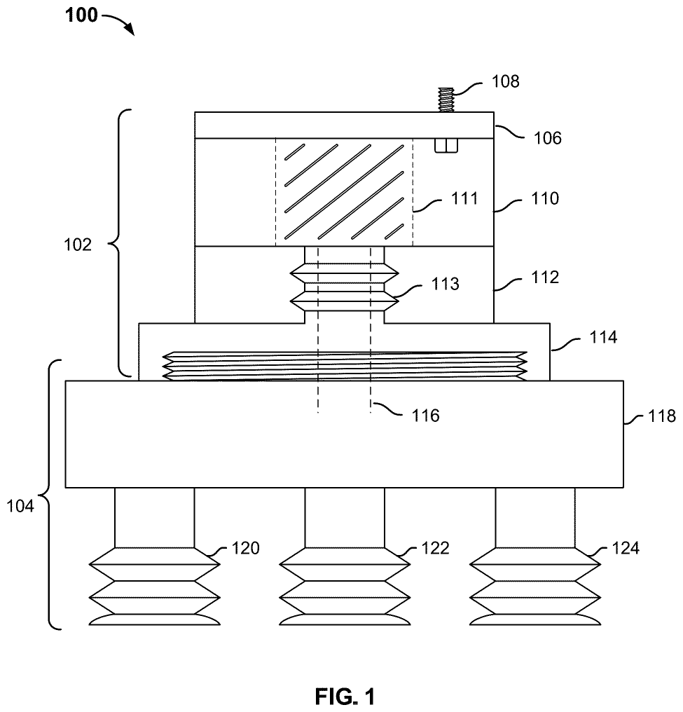

FIG. 1 is a diagram illustrating an embodiment of a universal gripper system with a palm installed.

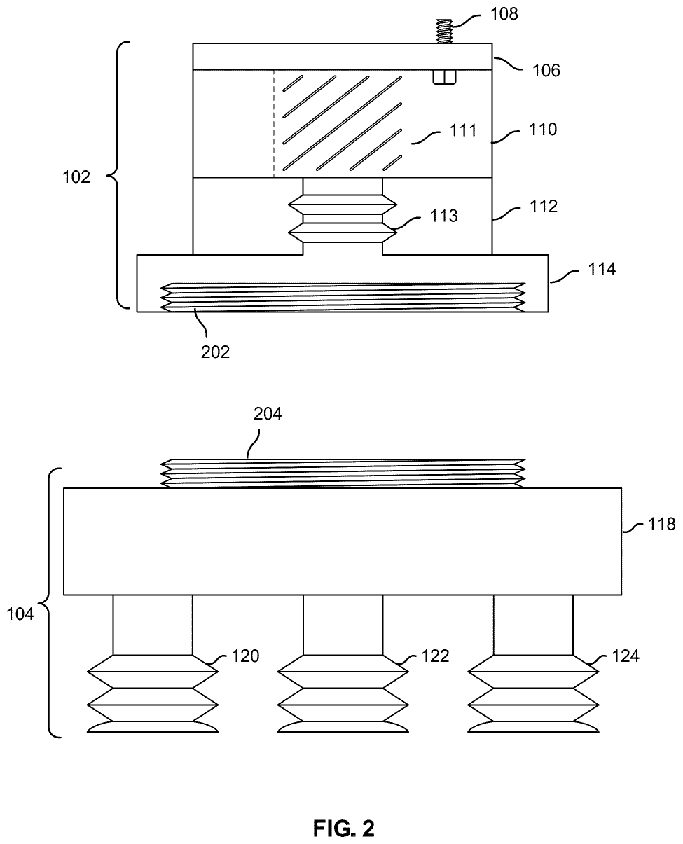

FIG. 2 is a diagram illustrating an embodiment of a universal gripper system with a palm detached.

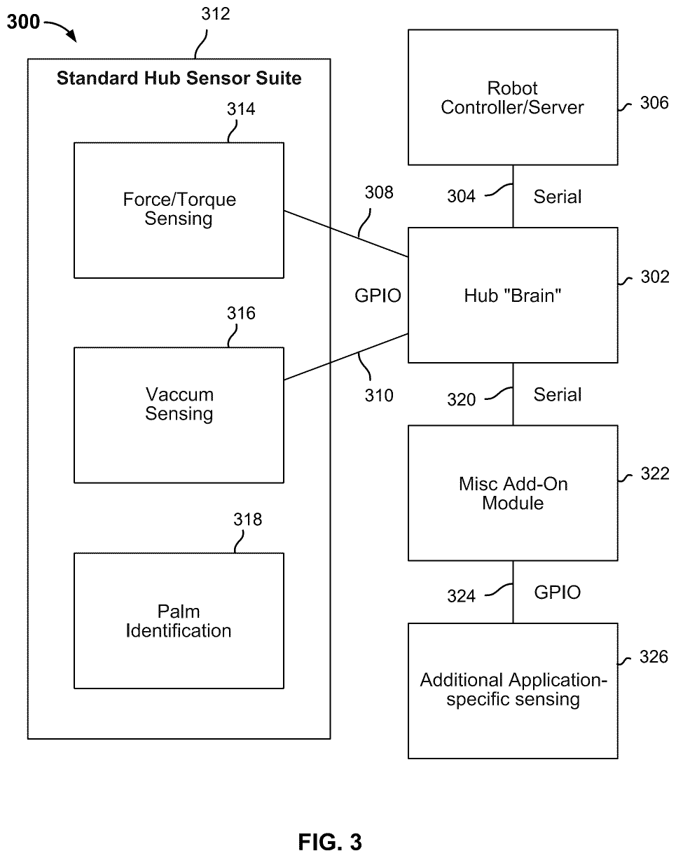

FIG. 3 is a block diagram illustrating an embodiment of control and sensing elements comprising a universal gripper system.

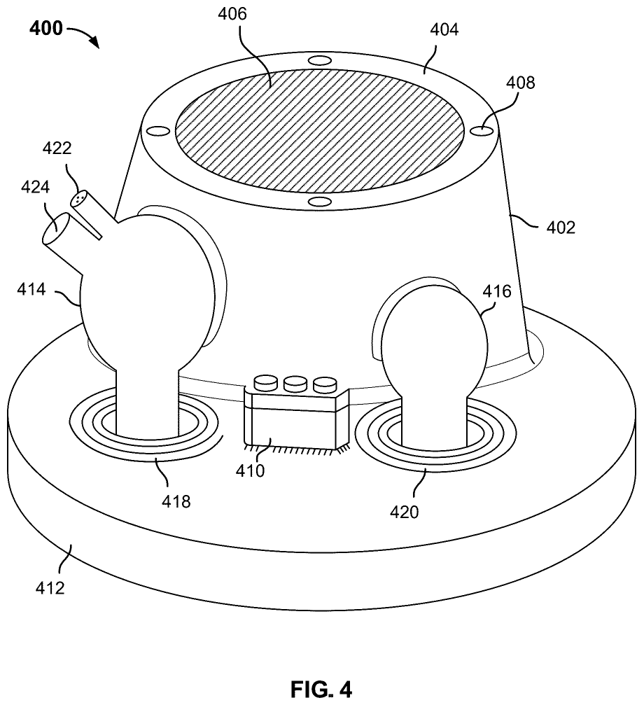

FIG. 4 is a diagram illustrating an embodiment of a universal gripper system.

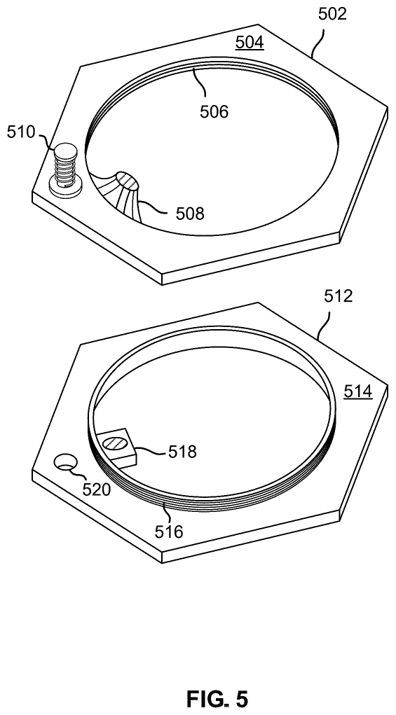

FIG. 5 is a diagram illustrating an embodiment of interconnection elements to connect a palm to a hub in an embodiment of a universal gripper system.

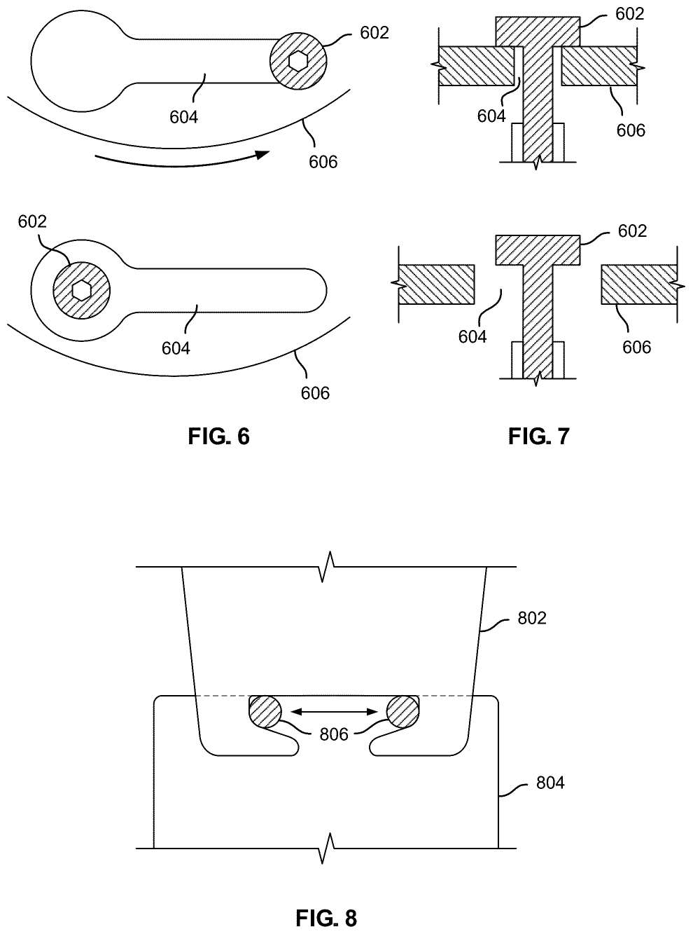

FIG. 6 is a diagram illustrating an embodiment of interconnection elements to connect a palm to a hub in an embodiment of a universal gripper system.

FIG. 7 is a diagram illustrating an embodiment of interconnection elements to connect a palm to a hub in an embodiment of a universal gripper system.

FIG. 8 is a diagram illustrating an embodiment of interconnection elements to connect a palm to a hub in an embodiment of a universal gripper system.

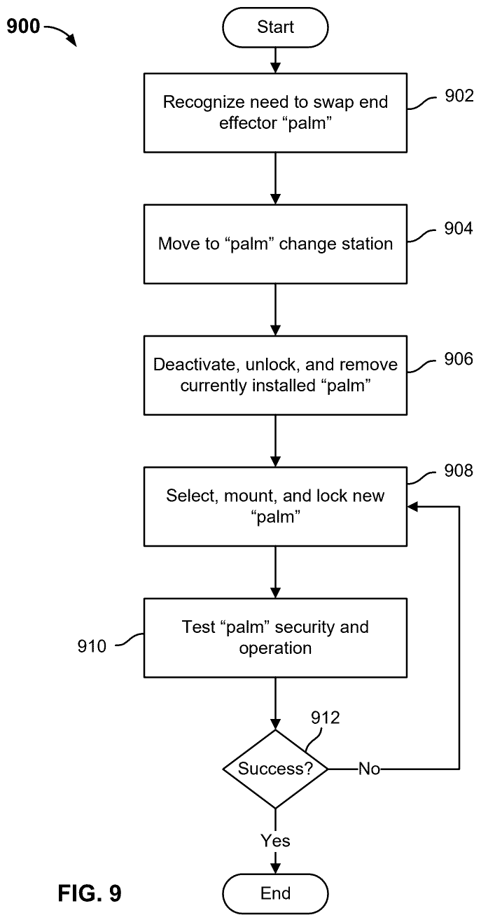

FIG. 9 is a flow diagram illustrating an embodiment of a process to autonomously change a gripper palm.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description to provide a thorough understanding of the invention. These details are provided for the purpose of example, and the invention may be practiced according to the claims without some or all these specific details. For clarity, technical material that is known in the technical fields related to the invention has not been described in detail so that the invention is not unnecessarily obscured.

A universal gripper system that can be used with minimal/no changes across variable robot sizes and applications is disclosed. In various embodiments, a gripper system as disclosed herein comprises a hub configured to be mounted to the distal end of a variety of different standard/commodity robotic arms, at a first end, and comprising a quick attach and release interface (or other end effector or tool connecting physical interface) at a second end, opposite the first end, to which one of a variety of end effector tools, sometimes referred to herein as “palms” may be affixed.

In various embodiments, the hub supplies vacuum, electrical power, and/or connections to transmit electrical and/or electronic signals, such as force sensor readings, image data from a camera, etc., without requiring separate hoses or cables to be routed outside or around the hub. Instead, vacuum, electrical power, and/or electrical/electronic signals are routed through paths that pass through the hub, at least in part. For example, vacuum may be supplied to the hub, e.g., from an external hose or other connection, and then passed through the hub to the end effector/tool.

In various embodiments, a quick attach and release mechanism facilitates quick changes between end effectors/tools (e.g., palms) while making a connection that is secure and strong enough to bear required loads.

In some embodiments, a robotic system as disclosed herein is configured to recognize the need/benefit to change the palm (end effector, tool, etc.). The system controls the robotic arm to move to a palm/tool changing station, activate a quick release of a currently affixed palm (e.g., activate solenoid, press palm against a surface and twist to unscrew it, etc.), and attach a new palm (move end of arm and hub into position an orientation opposite new palm, press and twist until pin or other structure clicks into place, etc.) and resumes work.

In various embodiments, a vacuum and other services may be passed to the end effector tool via an interface that minimizes interference with operation of sensors or other components. For example, force/torque sensors measure force (and compute torque) based on deflection. In some embodiments, vacuum is supplied by via a hub by a rigid (or somewhat or sufficiently rigid) tube inserted substantially vertically through a flexible air seal, enable movement around and with respect to the tube—as may be needed to measure force—without breaking the vacuum seal. In some embodiments, remaining effects on force/torque measurements are characterized (e.g., via a calibration process) and compensated for.

In various embodiments, a universal gripper system as disclosed herein includes one or more of the following features:
standard robot-side interface which all robots will mate with, requiring no variability in parts or assembly process
   includes standard dress pack interface allows standard approach to dress pack routing across robots
standard serial communication interface to add-on electrical modules; central end effector “hub” or “brain” has baseline functionality built-in (force/torque sensor, vacuum sensing) plus ability to adapt to infinite additional modules with additional features
   a microprocessor, microcontroller, or other processor in the hub performs computations and other functions
      provides backhaul of sensor readings, etc., via a shared bus, e.g., EtherCAT
standard tool-side quick-disconnect interface with vacuum interface, and optionally/as applicable electrical and/or electronic interfaces-supports infinite varieties of suction tool layouts, suction cups, actuators, and sensors
innovative force/torque sensor air passthrough minimizes force/torque dilution, minimizes number of parts, simplifies assembly, minimizes overall size of gripper for same performance
   standard design allows for modification or replacement of force/torque sensor to increase load capacity and sensitivity
   also allows usage of variable force sensors for widely variable applications, if necessary, without altering mating parts

FIG. 1 is a diagram illustrating an embodiment of a universal gripper system with a palm installed. In the example shown, universal gripper system 100 includes a universal hub assembly 102 and an interchangeable “palm” or “tool” 104. As shown, hub assembly 102 includes a robot interface 106 comprising a top-down flange, which is attached to the distal end of a robotic arm using bolts 108. The hub assembly 102 further includes force puck 110 and associated force/torque sensing layer 112, the force puck 110 being directly mounted to the robot via standoffs. Force puck 110 includes an internal air passage 111 that allows, for example, suction force to be supplied and/or serves as a conduit for electrical power, electronic sensor, and/or other connections. Suction (and cables) supplied via 111 is further provided to the palm 104 via flexible air passthrough 113 and passage 116, which runs through the twist-on quick-attach interface 114 and into a manifold or other vacuum connection within the palm 104.

Palm 104 comprises an interchangeable and application-specific gripper, in this example a suction type gripper (palm) comprising body 118 and suction cups 120, 122, 124.

In various embodiments, features such as flexible air passthrough 113 enable twist-on quick-attach interface 114, palm 104, and the attached load to exhibit deflection of strain gauges or other sensors comprising one or both of force puck 110 and force/torque sensing layer 112, enabling force and torque to be measured without causing a loss of vacuum or damage to the pathway via which the vacuum is supplied to palm 104.

FIG. 2 is a diagram illustrating an embodiment of a universal gripper system with a palm detached. Specifically, the universal gripper system 100 of FIG. 1 is shown with the palm 104 detached from hub assembly 102. In this view, hub assembly 102 can be seen to include a female threaded interface 202 into which male threaded interface 204 of palm 104 is inserted and rotated to attach palm 104 (e.g., to achieve the end state as shown in FIG. 1). To detach the palm 104, for example to install a different palm, the palm 104 is rotated in the opposite direction to unscrew the male threaded interface 204 of palm 104 from the female threaded interface 202.

In various embodiments, a human worker, other robot, or the robot itself may be configured to change the palm, e.g., to perform a different task and/or robotic application, by unscrewing one palm and screwing on another. In some embodiments, a robotic system may be configured to change the palm 104 for a different palm autonomously. For example, the system may perceive an object to be picked and placed and may determine the palm 104 is not a (or the most) suitable gripper to grasp the object. The system may move the robotic arm to palm changing station, place the palm 104 in a holder, and once the palm 104 is secured in the holder, rotate the robotic arm's wrist to decouple the hub assembly 102 and palm 104, leaving the palm 104 behind. The robotic system may then position the hub assembly 102 adjacent to a different palm, e.g., in a different nearby location, and may rotate the hub assembly 102 in the opposite direction to attach the new palm. The system may then move the robotic arm with the new palm attached to the hub assembly 102 and use the new palm to pick/place the object. In various embodiments, attaching the new palm results in vacuum (air), electrical (e.g., power), and/or electronic (e.g., sensor) connections being made, without operator intervention.

In various embodiments, a set of robots, e.g., robotic arms from different vendors, all have a standard mating interface for end effectors (grippers). All robots can use the same gripper hub and mate to it in the same way, e.g., bolted to a flange of the hub or directly to the gripper with standard mounting flange dimensions, hole placement, etc.

In various embodiments, a universal hub as disclosed herein provides for simple assembly/installation and may be standard on all robot systems. In various embodiments, the mating interface may comprise a bolted connection or a quick-connect mechanism. The standard interface may include dress pack connection points, e.g. for air (vacuum), electrical power, communications.

In some embodiments, the need for individual air connection points for each zone is eliminated (slow, error-prone, high chance of leakage). If gripper has different zones, e.g., two, three, or more sets of independently actuatable suction cups, in some embodiments a hub as disclosed herein receives a single vacuum input but includes structures and logic to supply vacuum selectively to the different zones.

In some embodiments, use of a universal hub as disclosed herein eliminates the need for separate connections for air lines and electrical lines. Instead, all services are connected to the hub at one point.

In some embodiments, use of a universal hub as disclosed herein enables all robots to have the same dress pack behavior near gripper, i.e., how tubes, wires, etc. are routed and protected. A single software solution may be used to predict dress pack behavior, instead of each robot system having different dress pack behavior.

In various embodiments, a universal gripper system as disclosed herein comprises an extensible architecture and supports standard serial communications with add-on modules.

FIG. 3 is a block diagram illustrating an embodiment of control and sensing elements comprising a universal gripper system. In the example shown, control and sensing elements 300 include a hub “brain” 302, e.g., a processor and/or a control module running on a processor, which is configured to communicate via serial interface 304 with robot system controller (and/or server) 306. Hub brain 302 sends sensor and other feedback data to the robot controller 306 and receives and acts on commands received from robot controller 306.

In the example shown, hub brain 302 communicates via general-purpose input/output (GPIO) interfaces 308, 310 with a standard hub sensor suite 312 comprising force/torque sensing module 314, vacuum sensing module 316, and palm identification module 318. The sensing modules comprising standard hub sensor suite 312 may be associated with sensors mounted on or in the universal hub, such as hub 102 of FIGS. 1 and 2, and/or which are present on all (or a subset of) palms or tools capable of being mounted on or by the hub 102. For example, force/torque sensing module 314 may process sensor readings from sensors comprising the universal hub, such as force puck 110 and/or force/torque sensing layer 112 of FIGS. 1 and 2.

Vacuum sensing module 316 may process readings from sensors on our in the hub, such as internal to the hub. In various embodiments, the hub may include one sensor (or a pair of sensors, for redundancy) in each of a plurality of separately controlled vacuum zones, e.g., to activate subsets of suction cups comprising a palm independently of each other.

Palm identification module 318 may use vision to identify the palm, or may read a memory location, RFID tag, or other data on or in the palm to determine its identity. The palm identification, in various embodiments, enables the system to determine the size capacity, weight capacity, and/or other performance characteristics of the palm. In some embodiments, the palm identification enables usage of a given palm, i.e., one have a specific unique identification number, e.g., to track usage like odometer, but cycles, time, size/weight/payload, etc. Palms may be replaced and/or their performance envelope varied based on age and usage. Replacement may be scheduled based on tracked usage.

In various embodiments, a universal gripper system as disclosed herein has one or more standard connectors and firmware to interact with miscellaneous add-on modules. Examples of such modules include, without limitation, modules for proximity sensing, cameras/vision systems, physical touch/haptic sensors, and actuators for augmenting suction gripping.

In the example shown in FIG. 3, hub brain 302 includes a serial interface 320 to a miscellaneous add-on module 322, which in turn may be connected via GPIO interface 324 to additional application-specific sensing modules, e.g., as described above.

FIG. 4 is a diagram illustrating an embodiment of a universal gripper system. In the example shown, universal hub assembly 400 includes an upper body 402 configured to be secured by bolts to a typical and/or standard robotic arm end effector interface. An outer wall 404 of upper body 402 defines an axial cavity 406 via which, for example, a vacuum may be applied and/or other cables, hoses, connectors, and/or services routed. Bolt holes 408 in outer wall 404 are configured to receive bolts to secure the universal hub assembly 400 to the robotic arm. The upper body 402 is coupled via a force/torque sensor 410 to a lower flange 412, which in turn is configured (via structures on the underside of flange 412 and not shown in FIG. 4) to receive and be coupled securely to an interchangeable palm.

Universal hub assembly 400 further includes vacuum passthroughs 414, 416, which are coupled to the upper body 402 in a manner that allows a vacuum applied to and/or supplied via axial cavity 406 to pass through the vacuum passthroughs 414, 416 and be supplied to a connected interchangeable palm via flexible seals 418, 420 and associated orifices through the lower flange 412. In various embodiments, the flexible seals 418, 420 enable vacuum passthroughs 414, 416 to move within a limited range relative to flange 412, which allows more rigid materials to be used for vacuum passthroughs 414, 416 while also allowing forces and torques applied to the palm and/or directly to the flange 412 to be measured using force torque sensor 410.

In the example shown, vacuum passthrough 414 is shown to have additional and/or optionally used electronic connector 422 and air (vacuum) connector 424, which are available to connect additional sensors and/or other devices and/or supply additional services to an attached palm via the vacuum passthrough 414.

In some embodiments, the hub “brain” performs computations to compensate for effect of hub structures and/or pressure differentials on force sensor readings. A force/torque sensor typically needs to flex/bend slightly to measure force/torque. In various embodiments, vacuum or other services are passed across the force/torque sensor comprising a universal hub as disclosed herein is passed via structures that do not interfere with the flexing of the force/torque sensor. Conventionally, such decoupling is achieved by spiraling long flexible vacuum hoses around the force/torque sensor, since flexible hoses can move/bend when force/torque sensor does. However, this solution is large, leakage-prone, difficult to assemble, not robust, etc. In some embodiments, in a hub as disclosed herein, vacuum is passed across the force/torque sensor with hard (or hard enough) passthrough pipes sealed within flexible lip seals, as in the example shown in FIG. 4. Pipes can move within the flexible lip seals, or slide through them, thus not interfering with force/torque sensor flexing.

Typically, when vacuum is passed across a force/torque sensor, the pressure difference between atmospheric pressure outside and vacuum inside causes a force to be read by the force/torque sensor. This force is not a real force applied to the gripper by the outside world. Typically, vacuum grippers with force/torque sensors ignore this force or attempt to tare (i.e., zero) it out. This only works if the externally applied forces that are relevant to the system are significantly larger than the force applied by internal vacuum.

In various embodiments, a hub or end effector as disclosed herein has internal vacuum sensors on each vacuum line. The internal “brain” monitors vacuum levels and force/torque sensor readings and automatically compensates the force/torque sensor readings, i.e., removes values associated with the vacuum lines, before reporting them to the robot control system.

In various embodiments, a universal hub assembly comprising a universal gripper system as disclosed herein includes a quick attach/quick release mechanism to enable palms to be attached and detached quickly and easily. In some embodiments, a robotic system as disclosed herein may be configured to change palms autonomously, e.g., as needed to perform different tasks. In some embodiments, a universal hub comprising a universal gripper system as disclosed herein includes a robotically controlled (or controllable) mechanism to detach and/or attach palms to the universal hub. For example, the universal hub may include a palm attachment mechanism that is mechanically, electrically, pneumatically, electronically, or otherwise activated and/or operated in response to an action perform by the robotic system, e.g., operating the robotic arm, and/or a command received from the robotic system and acted on by the hub “brain” comprising the universal hub.

FIG. 5 is a diagram illustrating an embodiment of interconnection elements to connect a palm to a hub in an embodiment of a universal gripper system. In the example shown, a palm quick disconnect interface 500 comprising a universal gripper system includes a hub side interface 502 having a lower (palm facing) face 504, a female threaded inner ring 506, vacuum supply fitting 508, to supply vacuum via the hub to the palm, when attached, and spring-loaded locking pin 510 to secure the palm to the hub. The palm side interface 512 has a hub facing upper face 514, male threaded raised ring 516, vacuum receiver fitting 518 (configured to receive and form a vacuum sealed connection to vacuum supply fitting 508), and hole 520 (configured to receive spring-loaded locking pin 510).

In various embodiments, a palm comprising palm side interface 512 is attached to a universal hub comprising hub side interface 502 by aligning male threaded raised ring 516 with female threaded inner ring 506 and rotating one or both of the palm and the universal hub to screw the palm side interface 512 into the hub side interface 502 until a mechanically secure connection is made and a non-leaking vacuum connection is established between vacuum supply fitting 508 and vacuum receiver fitting 518 and pin 510 extends into hole 520.

FIG. 6 is a diagram illustrating an embodiment of interconnection elements to connect a palm to a hub in an embodiment of a universal gripper system. In the example shown, palm interface 606 has an asymmetrically shaped slot 604, which has an opening at the left end (as shown) that is circular in shape and has a diameter that is larger than the transverse width of the remaining elongated portion (to the right as shown). A pin 602 on the hub side has a head with diameter such that it can pass through the circular opening on the left but not the portion on the right. A palm is attached by aligning the palm with the hub and moving the hub and/or palm such that the pin 602 enters and passes through the circular hole portion of slot 604, then rotating the palm clockwise (as viewed) to attach, as shown in the bottom image of FIG. 6. The palm interface is rotated in the opposite direction to detach, as shown in the upper image of FIG. 6.

FIG. 7 is a diagram illustrating an embodiment of interconnection elements to connect a palm to a hub in an embodiment of a universal gripper system. In the example shown, the upper image shows the T-shaped cross section of pin 602 of FIG. 6 positioned in the narrower portion of slot 604 of palm interface 606, while the lower image shows the pin 602 aligned with the larger, circular opening portion of slot 604, which would allow the pin 602 to be pulled through the opening 604 to remove the palm from the hub.

FIG. 8 is a diagram illustrating an embodiment of interconnection elements to connect a palm to a hub in an embodiment of a universal gripper system. In this example, hub interface 802 includes a recess into which spring-loaded pins 806 of palm interface 804 can be inserted. To attach a palm, pins 806 are squeezed together, slid into the recess, and then released, resulting in their springs pushing them outward laterally from each other and into the far sides of the recess, into the crevices as shown, enabling forces and torques applied to the palm to be transmitted to the hub. To remove the palm, the pins 806 are squeezed together and slid out of the recess.

FIG. 9 is a flow diagram illustrating an embodiment of a process to autonomously change a gripper palm. In various embodiments, the process 900 of FIG. 9 may be implemented by a robotic system configured to operate a robot comprising a universal gripper system as disclosed herein. In the example shown, at 902 the need to change to a different end effector “palm” or tool is detected. For example, computer vision may be used to determine the attributes of the next item to be picked and placed. If the currently affixed palm is not suitable or not the most suitable, the system may determine at 902 to change to a different palm. At 904, the system moves the robot to the palm changing station. The palms may be carried by or on the robot, in which case step 904 may include moving the distal end of the robotic arm into position to detach the current palm. At 906, the currently installed palm is deactivated, unlocked, and removed. For example, the palm and associated sensors may be powered down and vacuum disconnected or greatly reduced, to facilitate detaching the palm. Detachment is performed as required based on the hub to palm interface design, e.g., unscrewed, activate solenoid to retract a pin or other locking structure, etc. At 908, the new palm is selected, mounted, and locked into place. At 910, checks are performed to ensure the palm is attached securely and that vacuum, electrical, electronic, and other connections have been made. If at 912 the checks are determined to have indicated successful attachment, the process ends, otherwise steps 908 and 910 are repeated. In some embodiments, human intervention is requested if after a prescribed number of attempts a palm is not determined at 912 to have been successfully attached.

In some embodiments, the process 900 is fully autonomous. In other embodiments, human assistance may be required or requested. For example, some palms may require a human to connect a cable, air hose, etc.

In various embodiments, structures and techniques disclosed herein may be used to provide and operate a robotic system that can swap “palms” or other interchangeable tools quickly and efficiently, and in some embodiments autonomously, to perform a ranges of tasks.

Although the foregoing embodiments have been described in some detail for purposes of clarity of understanding, the invention is not limited to the details provided. There are many alternative ways of implementing the invention. The disclosed embodiments are illustrative and not restrictive.

1. A universal gripper system, comprising:
a hub body;
a mounting structure configured to enable the hub body to be connected to the distal end of a robotic arm;
a palm interface configured to removably mechanically couple to the hub body an interchangeable palm or tool; and
a resource supply structure configured to supply a resource to the interchangeable palm or tool.

2. The universal gripper system of claim 1, wherein the mounting structure comprises a flange.

3. The universal gripper system of claim 1, wherein the palm interface comprises a quick disconnect structure.

4. The universal gripper system of claim 1, wherein the palm interface is robotically operated.

5. The universal gripper system of claim 1, further comprising a sensor.

6. The universal gripper system of claim 5, wherein the sensor comprises a force-torque sensor.

7. The universal gripper system of claim 6, wherein the resource comprises a vacuum and the resource supply structure supplies the vacuum across the force-torque sensor.

8. The universal gripper system of claim 7, wherein resource supply structure is rigid and supplies the resource to the palm through the palm interface via a flexible seal.

9. The universal gripper system of claim 7, wherein the resource supply structure comprises a flexible air passthrough.

10. The universal gripper system of claim 1, wherein the interchangeable palm comprises an application-specific gripper.

11. The universal gripper system of claim 1, wherein the interchangeable palm comprises an application-specific suction gripper.

12. The universal gripper system of claim 1, wherein the palm interface comprises a threaded interface into or onto which the interchangeable palm or tool is screwed to attach the interchangeable palm or tool.

13. The universal gripper system of claim 1, further comprising a processor configured to communicate, via a communication interface, with a robot controller.

14. The universal gripper system of claim 12, wherein the robot controller is configured to send to the processor, via the communication interface, a command to operate a function of the universal gripper system.

15. The universal gripper system of claim 12, wherein the processor is further configured to communicate with one or more sensing modules.

16. The universal gripper system of claim 12, wherein the processor is further configured to communicate with a palm identification module configured to determine and report an identifying information associated with the interchangeable palm or tool.

17. The universal gripper system of claim 15, wherein one or both of the processor and the robot controller are configured to track usage of the interchangeable palm or tool.

18. The universal gripper system of claim 12, wherein the processor provides an extensible architecture configured to enable an add-on module to be added.

19. The universal gripper system of claim 1, wherein the resource comprises one or both of an electrical power supply and an electronic signal.

20. The universal gripper system of claim 1, wherein the resource supply structure passes through one or both of the hub body and the palm interface.
